(19) United States
(12) Patent Application Publication
(10) Pub. No.: US 2011/0011749 A1
(43) Pub. Date: Jan. 20, 2011

(54) Process for separation of an ion from a fluid mixture

(76) Inventor: Christian Gollmann, Springfield, OR (US)

Correspondence Address: GRADY K. BERGEN, 3333 LEE PARKWAY, SUITE 600, DALLAS, TX, 75219, US

(21) Appl. No.: 12/460,487

(22) Filed: Jul. 20, 2009

(51) Int. Cl. B01D 17/06; B05D 5/12

(52) U.S. Cl. 205/687; 204/290.03; 204/290.09; 204/230.8; 427/77

(57) ABSTRACT

A process for separation of a target ion from a fluid mixture containing the ion as well as a fluid non-ionic component includes flowing a mixture of the fluid and the ion through a separation zone containing positive and negative plates. The positive plate has a surface layer of negative polarity and the negative plate has a surface layer of positive polarity. An electrical potential is applied across the plates using a selected voltage. The mixture flows along at least one of the positive and negative plates such that target ions are attracted to the plate of opposite charge caused by the electrical potential. At the selected voltage, the surface layers of the positive plate and negative plates having the same polarity as an attracted positive or negative ion has surface groups that repel the attracted ions as they flow past the plate surface.

### FIELD OF THE INVENTION

The present invention relates to electrolytic chemical processes, especially for the separation of a contaminant or desired chemical species from a fluid mixture.

### BACKGROUND OF THE INVENTION

A variety of processes have been proposed for the removal of contaminants from liquids, such as removal of sulfur from hydrocarbons such as crude oil and diesel fuel, salt from sea water, and sulfur gases from fossil fuel emissions. Additional processes encompass mining for commercially valuable metals from seawater, subsurface water and tailage slurries. These processes, while effective, have not found widespread commercial application for reasons such as cost and insufficient purification. Such a process ideally can run continuously without need to replace parts such as filters that contain deposited, materials, but known processes generally lack these advantages.

A number of electrolytic desalination processes have been proposed. See Chang; et al. United States Patent Application 20080057398, Mar. 6, 2008. The system includes a power supply, a pump for transporting a liquid through the system, and a plurality of porous electrodes. The electrodes each include an electrically conductive porous portion. The electrodes may also include a substrate contiguous with the porous portion. The porous electrode can be utilized in electrodialysis and electrodialysis reversal systems. Membrane based systems are widely used, such as in Katsir United States Patent Application 20070251389, Nov. 1, 2007, which describes a vacuum deposited ceramic layer supported by a porous substrate. See also Linder United States Patent Application 20090001009, Jan. 1, 2009. Membrane based desalination systems generally require procedures for cleaning and/or changing the membrane. The present invention provides a system that does not depend on a permeable membrane for its effectiveness.

### SUMMARY OF THE INVENTION

A process of the invention for separation of a target ion from a fluid mixture containing the ion as well as a fluid non-ionic component includes an initial step of flowing a mixture of the non-ionic fluid and the ion through a separation zone containing a positive plate and a negative plate, wherein the positive plate has a surface layer of negative polarity and the negative plate has a surface layer of a positive polarity. An electrical potential is applied across the positive plate and negative plate using a selected voltage. The fluid mixture is flowed along at least one of the positive plate and negative plate to which the electrical potential has been applied such that target ions are attracted to the plate of opposite charge as caused by the electrical potential. At the selected voltage, the surface layer of the positive plate and negative plate having the same polarity as an attracted positive or negative ion has surface groups that repel the attracted ions as they flow past the plate surface, preventing plating of the attracted ions on the negative plate or positive plate. The process proceeds further by forming first and second streams, the first stream consisting essentially of the fluid non-ionic component and the second stream consisting essentially of the target ion; and then separately collecting the first and second streams from the separation zone.

The foregoing steps may if necessary be preceded by a step of converting the target species to ionic form. In the case of sulfur contained in fuels such as diesel fuel, organosulfur compounds in the fuel are first reacted with an oxidizing agent such as hydrogen peroxide. During this oxidative reaction sulfur bonds are weakened and/or broken. The normal chemical evolution would be the creation of sulfones and/or sulfoxides of the particular species of organosulfur compounds that are oxidized. However, upon applying a specific electrical potential to the hydrocarbon stream containing the organosulfur compounds the newly released or weakened sulfur ions (S-2) are immediately attracted to the positive electrode. Under an electrical potential field of the correct strength, the normal oxidative evolution of sulfones and sulfoxides from organosulfur compounds does not happen. All hydrocarbons are preserved with this process.

Certain terms have defined meanings when used herein and contrary interpretations are incorrect and unreasonable. For purposes of the invention “surface layer” means at or near the surface, that is, close enough to the surface to have the desired effect. The term “non-ionic fluid” refers to a fluid (gas or liquid) such as water or a hydrocarbon which in its normal state does not contain or generate more than trace amounts of free ions. For salt water, for example, the fluid is water and the target ions are Na+ and Cl−. The word “conductive” refers to electrical conductivity, and when two electrodes are “connected” it refers to an electrical connection. A “conductive base” refers to a base made of an electrically conductive material, or a plate of a semi-conductive or non-conductive material that has been coated with a conductive layer on which the ions are deposited. Other related words and terminology should be read in a manner consistent with the foregoing.

To collect the streams, an electrical potential is applied across the positive and negative plates using a selected voltage. The fluid mixture is made to flow between the plates to which the electrical potential has been applied such that positive ions are attracted to the negative plate, negative ions are attracted to the positive plate, and non-ionic components are not attracted to the plates. At the selected voltage, the surface layer of the negative plate and positive plate having the same polarity as the attracted positive or negative ions repel the attracted ions as they flow past the plate surface, preventing plating of the attracted ions on the negative plate or positive plate and forming substantially separate first and second streams. The first stream consists essentially of the fluid non-ionic component and the second stream comprises the target ion, residual flow medium such as water, and any other ionic species present. The first and second streams from the separation zone are collected to thereby separate the target ion(s) from the non-ionic fluid. The invention thus takes advantage of electrically created attractive forces applied by the negative plate and positive plate, while at the same time as repulsive surface charges prevent the attracted ions from sticking to or plating on the electrode surface.

The invention further provides, among other things, a separation chamber and specially prepared electrode plates for use in the process. An electrode plate configured for use in an electrolytic ion separation process of the invention comprises a base made of a conductive material, an ion layer consisting essentially of like-charged ions deposited on the base, and a conductive coating layer thinner than the base covering and sealing the layer of ions.

An apparatus of the invention for separation of a target ion from a fluid mixture containing the ion as well as a fluid non-ionic component includes a chamber having an inlet and pair of first and second outlets. Suitable means such as a pump is provided for flowing the fluid-ion mixture into the chamber through the inlet. A positive plate and a negative plate are positioned in the chamber to contact the fluid-ion mixture flowing through the inlet, wherein the positive plate has a surface layer of negative polarity and the negative plate has a surface layer of a positive polarity. An electrical circuit is configured to apply an electrical potential across the negative plate and positive plate at a voltage such that the surface layer of the negative plate and positive plate having the same polarity as the attracted positive or negative ions has surface groups that repel the attracted ions as they flow past the plate, hereby preventing plating of the attracted ions on the negative plate or positive plate. A neutral conductive plate may be provided between the positive and negative plates. This plate functions to stabilize the voltage within the separation chamber. It is not a separator of the kind used in batteries, and all of plates of the invention are non-porous for liquid media, but porous plates using the same technology can be used for removing contaminants from emissions.

A first outlet is positioned for removal of attracted ions from the chamber; and a second outlet is positioned for removal of non-ionic fluid medium from the chamber substantially separately from the attracted ions. Such an apparatus may use a single pair of spaced apart positive and negative plates, or a stack of spaced positive and negative plates wherein all of the negative plates are connected with each other and all of the positive plates are connected with each other and the electrical potential is applied to all plates to create a substantially uniform voltage in the chamber.

According to a further aspect of the invention, a process for forming an electrode plate configured for use in an electrolytic ion separation process includes steps of placing a base plate having a conductive surface in a working environment that is substantially moisture free, then depositing a layer of like charged ions on the conductive surface of the base. A sealing layer of a conductive material is then formed over the layer of ions, which sealing layer covers and seals the ions from exposure to the atmosphere when the plate is removed from the working environment. The sealing layer is sufficiently thin that the polarity of the layer of ions repels ions of opposite charge that come into contact with the sealing layer. Salts can provide the desired ions, such as Na+ or K+ and Cl−, but other strongly electropositive and electronegative ions can also be used.

Plates and other items having sealed layers of ions thereon according to the invention can also be used in other applications wherein the repulsive effect of the ions is useful. For example, water heater tanks are subject to calcium deposits. Lining the tank with a trapped positive ion layer according to the invention can prevent such calcium deposits. A sealed layer of positive ions is provided to repel the positive calcium ions and other positive ions that may be present. Thus, inside of tanks and pipelines wherein metal ions are present during normal use, a sealed ion layer according to the invention is provided. These and other aspects of the invention are discussed in the detailed description that follows.

### BRIEF DESCRIPTION OF THE DRAWING

In the accompanying drawing wherein like numerals denote like elements:

FIG. 1 is a schematic diagram of a separation chamber according to the invention;

FIG. 2 is a schematic diagram of a series of connected chambers according to the invention;

FIG. 3 is a sectional view of a positive electrode plate according to the invention; and

FIG. 4 is a sectional view of a negative electrode plate according to the invention.

### DETAILED DESCRIPTION

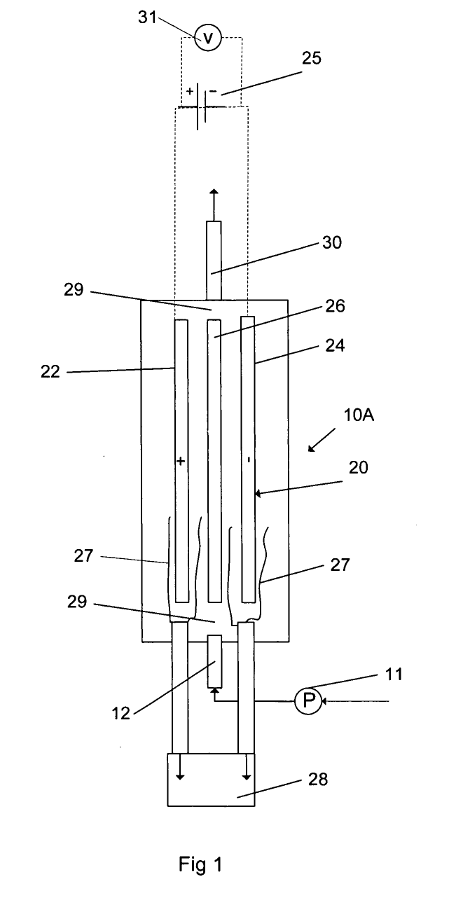

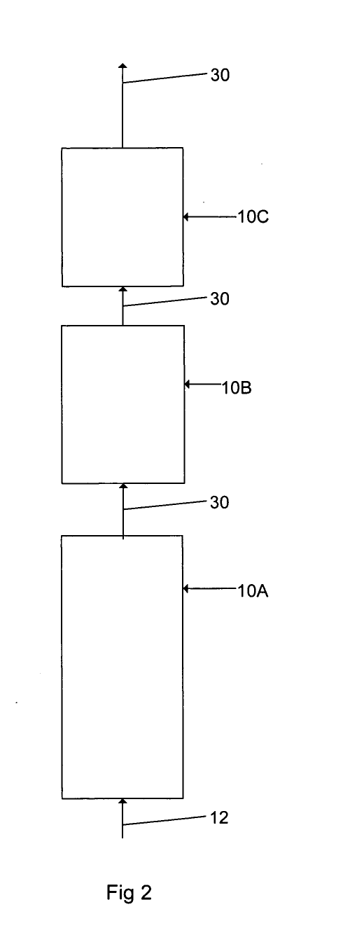

The following example applies the separation process of the invention to removal of salt from sea water. Referring to FIG. 1, a separation chamber 10A of the invention may comprise a cylindrical, vertically oriented housing having a bottom inlet 12. A pump 11 feeds a stream of sea water containing 35,000 ppm NaCl into chamber 10 through inlet 12. Sea water fills and flows upwardly inside of chamber 10 through an electrode assembly 20 as the process proceeds. Electrode assembly 20 comprises a pair of spaced electrode plates 22, 24 which can be made as described hereafter. A negative electrode plate 24 and a positive plate 22 are connected to an electrical power supply 25 to achieve a target voltage of 0.75V at the plates when sea water fills the chamber. In general, if the voltage is too high, ions deposit (plate) on the electrodes. As a result, the process works only temporarily. If the voltage is too low, then separation becomes insufficient. It is a significant advantage of the process of the present invention that it operates with low energy consumption and without use of filters. The applied electrical potential ranges from 0.5 to 5 volts, with values from 0.5 to 1 volt being preferred, especially from 0.7 to 0.8V. This level is sensitive to small differences in voltage; even 0.5 V may be too low for some types of electrodes and target ions, and 1.5 volts is usually too high. The process of the invention thus may be considered an ultra-low voltage system.

Plates 22, 24 each having a thickness of 3 mm are placed 50 millimeters apart and a neutral conductive plate 26 made of titanium coated with ruthenium oxide by the process described below is interposed between them. The word “conductive” used in the present invention refers to electrical conductivity. Plate 26 provides better control over the voltage level in chamber 10 and allows a constant voltage to be maintained. In this example, neutral plate 26 has a thickness of 3 mm and is paced from plates 22, 24 by 50 mm. Spaces 29 above and below plate 26 allow water flow to both sides of the chamber. Chamber 10 has a length of 650 mm in this example, and the electrode plates 22, 24 extend most of that distance. While titanium is used in the examples below as the base plate, other metals such as tantalum and other transition metals of the second and third series can provide better performance.

Plates 22 and 24 are not normal electrodes. Each has an “engineered charge” according to the invention. Negative plates 24 are constructed to have a surface positive charge created by positive ions trapped on or near the surface of the plate on both sides. Positive plates 22 are constructed to have a surface negative charge created by negative ions trapped on or near the surface of the plate on both sides. Engineered charge could also be accomplished by trapping nonionic species that have negative surface groups or positive surface groups.

An electrical potential 25 is applied to plates 22, 24 in order to create a negative charge on plates 24 and a positive charge on plates 22. The circuit can include a voltmeter 31 and optionally, a microprocessor control connected to the power supply for maintaining the voltage at a target level during the process. In each case the charge applies an attractive force to oppositely charged ions flowing past. For both positive and negative plates, the applied charge is more powerful than the weak repulsive force caused by the trapped ions on the surface of the plate, at least until ions are very close to the plate surface. Depending on the nature of the ion species flowing past, the voltage applied to plates 22, 24 is strong enough to attract oppositely charged ions but not strong enough, in view of the forces applied by the trapped surface ions, to cause plating of the ions on the plates. Plates 22, 24 may be coated on one side or both, and multiple positive and negative plates can be used spaced from one another in a stack, preferably wherein the negative plates are on the outside and the positive plates are on the inside. In this example, the Na+ and Cl− ions sink along the surfaces of plates 24 and 22 respectively due to gravity and flow into a pair of sleeves 27 covering the bottom 100 mm of each plate 22, 24 with a spacing of about 1 mm from the plate surface. Sleeves 27 help to prevent mixing of ions removed by the electrodes with incoming sea water from inlet 12. For this purpose sleeves 27 are each made of nonconductive material such as neoprene rubber or molded fiberglass. Sleeves 27 can be lined or coated with Teflon or a similar material to which the material removed from the fluid is less likely to stick. Sleeves 27 have openings at their lower ends by which ions from chamber 10 enter an over-concentration chamber 28 wherein they react to form salt. A high salt concentration builds in chamber 28, which is periodically emptied as needed, i.e. manually or the contents are drained to a storage tank.

As the process continues, purified water exits chamber 10 from an outlet 30 at its top. Water flowing through outlet 30 of chamber 10A is reduced to about 10,000 ppm salt. It is conducted to the inlet 12 of a second chamber 10B which is identical to chamber 10A except that the electrode plate spacing is about 10 mm and chamber 10B is shorter than 10A (in this example 250 mm long). Water leaving chamber 10B through outlet 30 enters inlet 12 of a third chamber 10C wherein the plate spacing is 3 mm and the length is again 250 mm. Progressively lower salt content is obtained after each successive treatment. Other minerals in the water are removed together with the salt.

The flow rate through the system (all of chambers 10A-10C) is kept constant based on the capacity of each chamber. Flow is controlled using TDS meter and adjusted to the desired salt concentration as measured in microsiemens. This allows a constant quality of 100 ppm salt or less at the outlet 30 of chamber 10C. Clean water exits chamber 10C and ions in chambers 28 are concentrated and form salt molecules.

The separation chamber 10 according to the invention needs to have sufficient flow velocity to sustain continuous removal of the target ions from the mixed stream. Faster flow also makes it less likely that ions will plate on an electrode. The actual flow rate will vary depending on the size of the chamber and flow paths, the degree of purification (ion separation) desired, and the nature of the system, i.e. the plates and the surface layers on the plates. The flow rate could thus vary over a wide range, but a minimum of 35 gallons per minute is preferred for commercial use. For salt water progressing through chambers 10A-10C. If necessary two or more third chambers 10C can operate in parallel each receiving part of the purified flow from chamber 10B, and multiple systems 10A-10C can be deployed to operate on a large scale, e.g. one million gallons of sea water treated per day.

Unexpectedly, temperature is not an essential factor to the process of the invention. Heating is not needed. It is an advantage of the invention that it can run at or near room temperature (20° C.). In each chamber 10, especially in more closely spaced chamber 10C, it may be useful to provide a stack of spaced positive and negative plates as described herein to increase the degree of purification and the amount of salt water that can be treated.

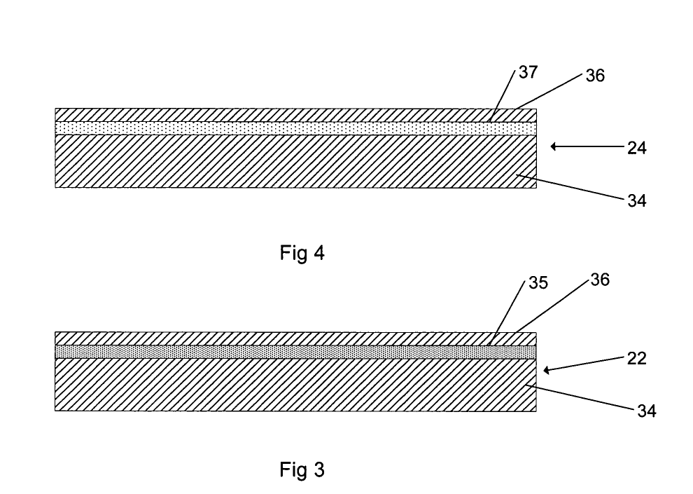

As shown in FIGS. 3 and 4, a positive plate (anode) 22 according to the invention has an engineered negative charge wherein a layer 35 of negative (chloride Cl−) ions is deposited on a conductive metal oxide base 34 and sealed by a thin conductive metal oxide coating layer 36. Layer 36 is thinner than base 34 and is thin enough to permit the underlying ion charges to affect oppositely charged ions passing by coating layer 36. Negative plate (cathode) 24 has the same layers as plate 22, except that layer 35 is replaced by a layer 37 of positive ions such as Na+.

### EXAMPLE

### Fabrication of Electrode Plates

A negative plate is prepared having a permanent ionic positive polarity on its surface. Base metal of the negative plate is titanium, but other metals can be used. During the coating process, humidity of the work environment should be kept as low as possible. Base coating is preceded by sandblasting of the titanium plate increase surface area. The plate is cleaned with MIBK (methyl isobutyl ketone (organic solvent) to remove all organic material, and then dipped in a bath of isopropyl alcohol (can be other alcohols or solvents) and tantalum oxide (other conductive metals and metal oxides can be used). The plate is then pulled from the bath and spun to assure an even coat, then baked at a temperature of approximately 316° C. (600° F.) for sufficient time to create a fused ceramic coat, and allowed to cool slowly. This leaves a thin, highly conductive ceramic coating of tantalum oxide over the base metal titanium and seals the titanium plate.

To provide a permanent positive ionic charge, the tantalum oxide coated plate is dipped into a bath of raw sodium dissolved in isopropyl alcohol. Another element that forms a positive ion can be used, and other alcohols or solvents can be used. The plate is then pulled from the bath and spun to assure an even coat. It is then baked at a temperature of 149° C. (300° F.) for a time sufficient to vaporize the alcohol base, and allowed to cool slowly. This leaves positive sodium ions fused to the ceramic tantalum oxide surface. The coating process is repeated in order to increase sodium ion density and thus strengthen the positive charge of the plate. As many as fifty coats are not uncommon to achieve the desired charge strength depending upon the strength of the dissolved sodium within the isopropyl alcohol bath.

Upon achieving the desired charge strength, the plate is immersed in a bath of isopropyl alcohol or other alcohols or organic solvents. Seal coating then commences using highly conductive ruthenium oxide, although other metals or metal oxides can be used. The plate is spun to assure an even coat. It is then baked at a temperature of 649 to 982° C. (1,200 to 1,600° F.) or a time sufficient to create a strong ceramic sealing coat and allowed to cool incrementally for several hours. The ceramic coating of ruthenium oxide seals the highly reactive sodium from reacting with the outside environment, but the positive charge of the sodium ions exerts electrical force through the thin sealing layer.

The coatings on the titanium base are thereby engineered to provide a permanent positive ionic charge sealed within a highly conductive, non-reactive ceramic coating of tantalum and ruthenium oxide. This is done on both sides of the plate in like manner to provide a plate that can be used as a negative plate in the separation chamber according to the invention. However, a single-sided electrode can be used.

A positive plate having a permanent ionic negative polarity is also prepared. A titanium plate is prepared for coating, including sandblasting and cleaning, in the same manner as described for the negative plate above. The plate is then dipped in a bath of isopropyl alcohol and tantalum oxide. The plate is then pulled from the bath and spun to assure an even coat, then baked at a temperature of approximately 316° C. (600° F.) or for sufficient time to create a fused ceramic coat, and allowed to cool slowly. This leaves a thin, highly conductive ceramic coating of tantalum oxide over the base metal titanium and seals the titanium positive plate from electron donation and anode depletion at voltages above approximately 1.5 volts.

To provide a negative ionic charge, the tantalum oxide plate is dipped into a bath of titanium tetrachloride dissolved in isopropyl alcohol (other chloride compounds can be used) that after heating would leave a negative ion (Cl−) on the ceramic plate. The plate is then pulled from the bath and spun to assure an even coat. It is then baked at 149° C. (300° F.) for a time sufficient to vaporize the alcohol base and allowed to cool slowly. This leaves chloride ions fused to the ceramic tantalum oxide surface. The coating process is repeated in order to increase the chloride ion density and thus strengthen the negative charge of the plate. As many as fifty coats are not uncommon to achieve the desired charge strength, depending upon the concentration of the dissolved titanium tetrachloride within the isopropyl alcohol bath.

Upon achieving the desired charge strength, the plate is immersed in a bath of isopropyl alcohol and highly conductive ruthenium oxide (could be other conductive metals and metal oxides) and spun to assure an even coat. It is then baked at a temperature of 649 to 982° C. (1,200 to 1,600° F.) for a time sufficient to create a strong ceramic seal and allowed to cool for several hours. The ceramic coating of ruthenium oxide seals the highly reactive chloride ions from reacting with the outside environment. The coatings on the titanium are thus engineered to provide a permanent negative ionic charge sealed within a highly electrically conductive, non reactive ceramic coatings of tantalum and ruthenium oxide. Less expensive plates can be used for removal of salt from seawater, for example both plates can be made of titanium coated with a conductive metal oxide over and under the deposited ion layers. The foregoing plates using transition metals of the second and third series that form conductive oxides are suited for use in the invention, especially for separation of sulfur and nickel ions from a mixture wherein the fluid medium is a hydrocarbon fuel such as kerosene or diesel fuel.

It will be understood that the foregoing description is of preferred exemplary embodiments of the invention, and that the invention is not limited to the specific forms described and illustrated. For example, the means for flowing a mixture through the chamber can be a pump, or could rely on gravity flow or, pressure, i.e. expansion where the fluid is a gas. These and other modifications may be made in without departing from the spirit of the invention. It is the intent that the appended claims be interpreted as broadly as possible in view of the prior art as to include all such variations and modifications.

1. A process for separation of a target ion from a fluid mixture containing the ion as well as a fluid non-ionic component:
flowing a mixture of the non-ionic fluid and the ion through a separation zone containing a positive plate and a negative plate, wherein the positive plate has a surface layer of negative polarity and the negative plate has a surface layer of a positive polarity;
applying an electrical potential across the positive plate and negative plate using a selected voltage;
flowing the fluid mixture along at least one of the positive plate and negative plate to which the electrical potential has been applied such that target ions are attracted to the plate of opposite charge created by the electrical potential;
wherein at the selected voltage, the surface layers of the positive plate and negative plate having the same polarity as an attracted positive or negative ion have surface groups that repel the attracted ions as they flow past the plate surface, preventing plating of the attracted ions on the negative plate or positive plate, forming first and second streams, the first stream consisting essentially of the fluid non-ionic component and the second stream comprising the target ion; and
separately collecting the first and second streams from the separation zone.

2. The process of claim 1, wherein the fluid mixture contains both positive and negative ions, such that the negative ions are attracted to the positive plate, positive ions are attracted to the negative plate, and the non-ionic fluid component is not attracted to the positive plate or negative plate.

3. The method of claim 1; wherein the electrical potential ranges from 0.5 to 1 volt.

4. The method of claim 1, further comprising a step forming the fluid-ion mixture by conducting a reaction that forms positive and negative ions in the non-ionic fluid component.

5. The method of claim 1, wherein the positive and negative ions are Na+ and Cl− and the non-ionic fluid is liquid water.

6. An electrode plate configured for use in an electrolytic ion separation process, comprising:
a conductive base;
an ion layer consisting essentially of like-charged ions deposited on the base; and
a conductive coating layer covering and sealing the layer of ions.

7. The plate of claim 6, wherein the ions are all positively charged.

8. The plate of claim 6, wherein the ions are all negatively charged

9. The plate of claim 7, wherein the ions comprise Na+.

10. The plate of claim 8, wherein the ions comprise Cl−.

11. The plate of claim 6, wherein the coating layer consists essentially of a conductive metal oxide.

12. The plate of claim 1, wherein the base is coated with a layer made of a first conductive metal oxide and the coating layer consists essentially of a second conductive metal oxide.

13. The plate of claim 12, wherein the base is made of titanium, the first conductive metal oxide comprises tantalum oxide, and the second conductive metal oxide comprises ruthenium oxide.

14. An apparatus for separation of a target ion from a fluid mixture containing the ion as well as a fluid non-ionic component, comprising:
a chamber having an inlet and pair of first and second outlets;
means for flowing the fluid-ion mixture into the chamber through the inlet;
a positive plate and a negative plate positioned in the chamber to contact the fluid-ion mixture flowing through the inlet, wherein the positive plate has a surface layer of negative polarity and the negative plate has a surface layer of a positive polarity;
an electrical circuit for applying an electrical potential across the negative plate and positive plate at a voltage such that the surface layer of the negative plate and positive plate having the same polarity as the attracted positive or negative ions has surface groups that repel the attracted ions as they flow past the plate, preventing plating of the attracted ions on the negative plate or positive plate;
wherein the first outlet is positioned for removal of attracted ions from the chamber; and
a second outlet positioned for removal of non-ionic fluid medium from the chamber substantially separately from the attracted ions.

15. A process for forming an electrode plate configured for use in an electrolytic ion separation process, comprising:
placing a base plate having a conductive surface in a working environment that is substantially moisture free;
depositing a layer of like charged ions on the conductive surface of the base;
then forming a sealing layer of a conductive material over the layer of ions, which sealing layer covers and seals the ions from exposure to the atmosphere when the plate is removed from the working environment and is sufficiently thin that the polarity of the layer of ions repels ions of opposite charge that come into contact with the sealing layer.

16. The process of claim 15, wherein the depositing and forming steps are each conducted on opposite faces of the base.

17. The process of claim 15, wherein sealing layer is made of a conductive metal oxide.

18. The process of claim 15, further comprising forming the base by depositing a conductive metal oxide layer on a surface of a metal plate, and the ion layer is formed on the conductive metal oxide layer.

19. The process of claim 18, wherein the metal plate is a titanium plate and the metal oxides of the surface layer on the base and the coating are oxides of transition metals of the second and third series.
